(19) United States
(12) Patent Application Publication
(10) Pub. No.: US 2015/0075148 A1
(43) Pub. Date: Mar. 19, 2015

(54) HYDRAULIC CONTROL SYSTEM

(71) Applicant: Kenpei Yamaji, Ryugasaki-shi (JP)

(72) Inventor: Kenpei Yamaji, Ryugasaki-shi (JP)

(21) Appl. No.: 14/236,905

(22) PCT Filed: May 18, 2012
(86) PCT No.: PCT/JP2012/003262

§ 371 Date: Feb. 3, 2014

(51) Int. Cl. F15B 9/04; E02F 9/22; F15B 13/04; F15B 13/06; F15B 13/01; F15B 13/044

(52) U.S. Cl. CPC F15B 9/04; F15B 13/01; F15B 13/044; F15B 13/0401; F15B 13/06; E02F 9/2235; E02F 9/2296
USPC 60/420; 60/433

(57) ABSTRACT

A hydraulic control system is provided in which hydraulic oil discharged from a variable displacement hydraulic pump is controlled and supplied to a hydraulic actuator by a closed center control valve activated based on operation input from an operation device, thereby controlling activation of the hydraulic actuator. With the pump displacement detected by pump displacement detecting means and the pump output pressure detected by pump output pressure detecting means being used as feedback input and the characteristic value determined by the operation input and the feedback input being used as a target value of a control loop, variable displacement control is performed by a controller provided with a horsepower control loop, a pressure control loop, a flow rate control loop, and a minimum pressure holding loop that feed back a calculated value based on the feedback input or the feedback input itself.

### TECHNICAL FIELD

The present invention relates to a hydraulic control system suitable for performing hydraulic control in a construction machinery such as a hydraulic—excavator. More specifically, the invention relates to a hydraulic control system for performing activation of a hydraulic actuator used in a construction machinery or the like.

### TECHNICAL BACKGROUND

In a construction machinery such as a hydraulic excavator, there is a configuration of a hydraulic control system in which a plurality of hydraulic actuators such as hydraulic cylinders or hydraulic motors are used and the activation of the hydraulic actuators is controlled to perform predetermined work. Therefore, the configuration is such that hydraulic pumps are driven by an engine, or more recently, a drive source such as an electric motor, and the hydraulic power supplied from the hydraulic pump is controlled by hydraulic control valves in accordance with the operation of operating levers or the like by an operator and supplied to each actuator (e.g., see Patent Document 1).

In a conventional hydraulic control system such as that shown in Patent Document 1 mentioned above, a directional control valve with center bypass gallery is used as the hydraulic control valve. When the operating lever is in neutral, oil supplied from the hydraulic pump passes through a center bypass gallery and is returned to a tank. The configuration is such that, when the operating lever is operated, the center bypass gallery is closed in accordance with the operation, and activation of the directional control valve is controlled so as to perform supply of the oil to the hydraulic actuator in accordance with the operation.

### PRIOR ARTS LIST

### Patent Document

Patent Document 1: Japanese Laid-Open Patent Publication No. 2007-23606(A)

### SUMMARY OF THE INVENTION

### Problems to be Solved by the Invention

In such a conventional hydraulic control system, the configuration is such that the center bypass gallery gets closed along with an increase in operation input to increase the pump output pressure and control the flow rate to load. Therefore, there is a large energy loss in neutral and directional switching range of stroke of the control valve, posing a problem that deterioration in the controllability occurs due to hydro flow force generated in a center bypass notch.

The present invention has been made in view of such a problem, and it is an object to provide a hydraulic control system with a configuration in which displacement control of a pump is performed using a closed center directional switching valve and that can reduce energy loss as well as ensure controllability.

### Means to Solve the Problems

In order to achieve the object, the present invention is configured as a hydraulic control system in which hydraulic oil discharged from a variable displacement hydraulic pump is controlled and supplied to a hydraulic actuator by a closed center control valve activated based on operation input from an operation device to control activation of the hydraulic actuator, this hydraulic control system including: pump displacement detecting means for detecting a displacement of the hydraulic pump; and pump output pressure detecting means for detecting an output pressure of the hydraulic pump, the hydraulic pump being configured such that, with a pump displacement detected by the pump displacement detecting means and a pump output pressure detected by the pump output pressure detecting means being used as feedback input and a characteristic value determined by the operation input and the feedback input being used as a target value of a control loop, variable displacement control is performed by a controller provided with a horsepower control loop, a pressure control loop, a flow rate control loop, and a minimum pressure holding loop that feed back a calculated value based on the feedback input or the feedback input itself, and the controller being provided with a selector unit that selects any of the plurality of loops in correspondence with the operation input and the feedback input, so that any loop out of a plurality of the loops is selected by the selector unit and variable displacement control of the hydraulic pump is performed based on a control value from the selected loop.

In the hydraulic control system, it is preferable that a plurality of hydraulic actuators be provided, a characteristic value table of flow rate, pressure, and horsepower corresponding to the operation input and the feedback input be set for each of the plurality of the hydraulic actuators, and target values of flow rate, pressure, and horsepower in the plurality of loops be determined with reference to the characteristic value tables.

In the hydraulic control system, it is preferable that the selector unit

(1) selects a minimum pressure holding loop when the operation input indicates that the operation device is in a neutral position,

(2) selects the pressure control loop when the operation input indicates that the operation device is off the neutral position and the pump displacement is less than or equal to a leakage flow of a hydraulic oil supply circuit for the hydraulic actuator and that the hydraulic actuator is in a state before activation,

(3) selects the horsepower control loop when the operation input indicates that the operation device is off the neutral position and the pump displacement becomes greater than the leakage flow of the hydraulic oil supply circuit for the hydraulic actuator and is less than or equal to a displacement determined by the operation input signal, and

(4) selects the flow rate control loop when the operation input indicates that the operation device is off the neutral position and the pump displacement is a displacement exceeding the displacement determined by the operation input signal.

In the hydraulic control system, it is preferable that the selector unit

(5) selects the minimum pressure holding loop when the pump output pressure detected by the pump output pressure detecting means has become smaller than a minimum allowable pressure, regardless of the operation input.

In the hydraulic control system, it is preferable that the selector unit

(6) selects the flow rate control loop in a case where the operation input has suddenly decreased due to a sudden operation to neutral, and control of forcefully reducing the displacement of the hydraulic pump be performed by the flow rate control loop. Accordingly, occurrence of a surge pressure is prevented.

In the hydraulic control system, it is preferable that, when a selection of shifting from the pressure control loop to the horsepower control loop has been performed, the characteristic value of the horsepower control table be caused to vary by referring to a pressure exhibited when the actuator overcomes a load pressure and starts activation. Accordingly, the shift from pressure control to horsepower control is done smoothly.

In the hydraulic control system, it is preferable that the controller be configured to control activation of the closed center control valve based on the operation input and the pump output pressure, and opening control in the closed center control valve is to be caused to coordinate with displacement control of the hydraulic pump so as to make a start of opening have a characteristic, in which a pressure exhibited when overcoming a load pressure to start activation is used as a reference (i.e., such that opening is greater when the load pressure is low and opening is smaller when high), by taking into consideration that the variable displacement hydraulic pump changes its flow rate increasing characteristic under the influence by the output pressure (load pressure).

### Advantageous Effects of the Invention

With the present invention, as described above, improvement can be made in energy loss in a center bypass notch and deterioration of controllability while ensuring a control characteristic achieved with a center bypass circuit, by using a closed center directional switching valve to eliminate a center bypass circuit and controlling the displacement control of a pump (tilt control of a pump) with a controller through electricity.

### BRIEF DESCRIPTION OF THE DRAWINGS

FIG. 1 is a control circuit diagram showing the configuration of a hydraulic control system to which the present invention is applied;

FIG. 2 is a control circuit diagram showing the hydraulic control system in detail;

FIG. 3 is a diagram showing a table used for determining the target value of pressure, flow rate, and horsepower with respect to operation input;

FIG. 4 is a diagram showing the horsepower and pressure characteristic with respect to operation input;

FIG. 5 is a diagram showing the constant horsepower characteristic through the relationship with pressure and flow rate;

FIG. 6 is a diagram showing the horsepower and pressure characteristic with respect to operation input;

FIG. 7 is a diagram showing the flow rate characteristic with respect to operation input;

FIG. 8 is a diagram showing the flow rate characteristic with respect to operation input;

FIG. 9 is a diagram showing the control characteristic of the valve spool opening area with respect to operation input; and

FIG. 10 is a schematic configuration diagram showing a conventional load sensing pump control system.

### DESCRIPTION OF THE EMBODIMENTS

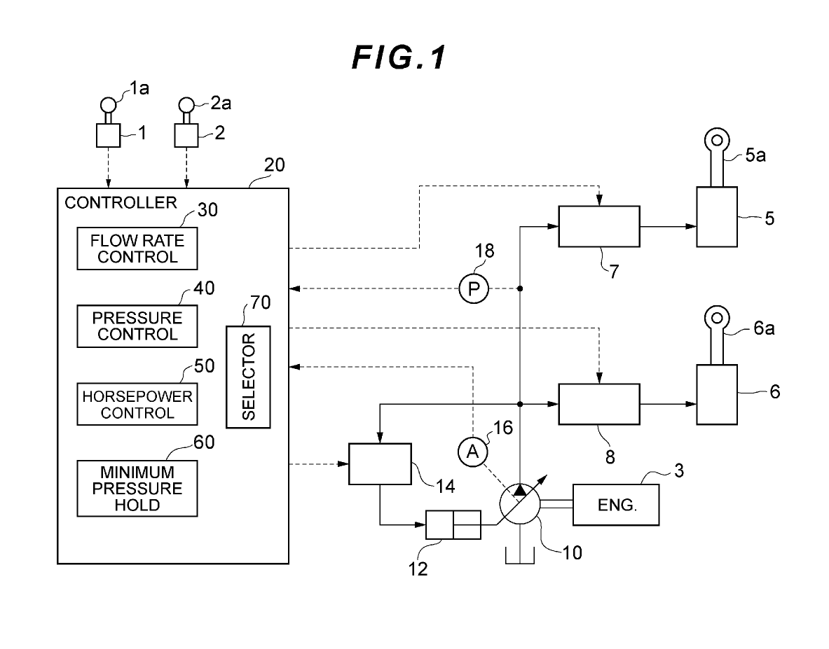

Hereinafter, a preferred embodiment of the present invention will be described with reference to the drawings. FIG. 1 schematically shows the configuration of a hydraulic control system to which the present invention is applied. The hydraulic control system performs control of activating an actuator of a hydraulic excavator, for example, in accordance with the operation of an operating lever, and the configuration is such that pistons 5a and 6a of first and second hydraulic actuators 5 and 6 are extended and retracted in accordance with the operation of operating levers 1a and 2a in the first and second operation devices 1 and 2 by an operator to control activation of the hydraulic excavator. In an actual hydraulic excavator, more operation devices and hydraulic actuators are provided. However, for a simple description, the hydraulic control system and a control method using the same will be described below with an example of the two operation devices 1 and 2 and the two hydraulic actuators 5 and 6.

As a hydraulic pressure generating source, a hydraulic pump 10 rotated and driven by an engine 3 is provided. Oil discharged from the hydraulic pump 10 is supplied to the first and second hydraulic actuators 5 and 6 via first and second control valves 7 and 8. The hydraulic pump 10 is a swash plate- or vent axis-type hydraulic pump capable of discharge displacement control through variable control of the tilt angle, and the tilt angle variable control is performed by a tilt driving cylinder 12. For the tilt driving cylinder 12, hydraulic oil supply control is performed by a tilt control valve 14, whereby activation of the tilt driving cylinder 12 is controlled to perform discharge displacement control of the hydraulic pump 10. At this time, a tilt angle sensor 16 that detects a swash plate or vent axis tilt angle A (i.e., pump discharge displacement) of the hydraulic pump 10 and a hydraulic sensor 18 that detects a discharge hydraulic pressure P of the hydraulic pump 10 are provided. The first and second control valves 7 and 8 are closed center directional control valves that, in neutral position, block connection of an oil path between the hydraulic pump 10 and the first hydraulic actuator 5 or the second hydraulic actuator 6.

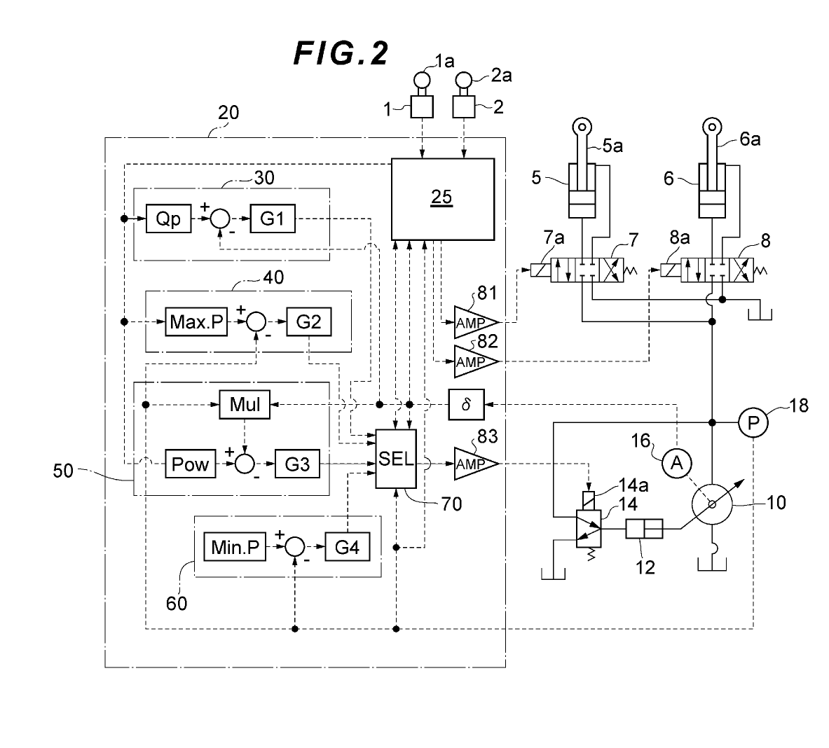

In order to control activation of the tilt control valve 14 and the first and second control valves 7 and 8, a controller 20 is included. The controller 20 is input with an operation signal from the first and second operation devices 1 and 2, a tilt angle signal of the hydraulic pump 10 detected by the tilt angle sensor 16, and an output pressure signal of the hydraulic pump 10 detected by the hydraulic sensor 18, and controls activation of the tilt control valve 14 and the first and second control valves 7 and 8 in accordance with the signals. The configuration of the controller 20 will be described below also with reference to FIG. 2.

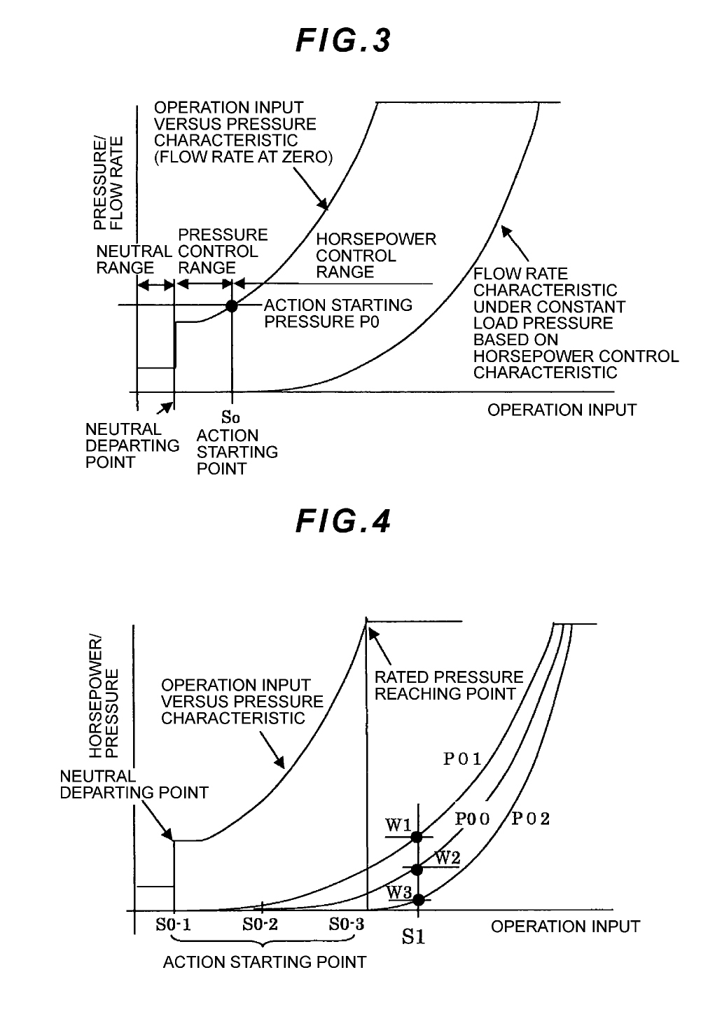

The basic configuration of the controller 20 is shown in FIG. 1. A flow rate control loop unit 30, a pressure control loop unit 40, a horsepower control loop unit 50, a minimum pressure holding loop unit 60, and a selector unit 70 are provided. The detailed configuration is shown in FIG. 2. The controller 20 is further provided with a characteristic value table storage unit, as a main component, storing various tables (e.g., pressure versus operation input table shown in FIG. 3, flow rate versus operation input table, horsepower versus operation input table, and the like) described later, a system management unit 25 that performs logical operation or sequential operation for causing outputs of a selector, amplifier, or the like to function in an integrated manner, first to third amplifiers 81 to 83, and the like.

The first and second control valves 7 and 8 are activated and controlled by the controller 20 in accordance with the operation of the operating levers 1a and 2a. Basically, switching control of the supply direction of hydraulic oil is performed in accordance with the operating direction of the operating levers 1a and 2a, and opening degree control is performed in accordance with the operating lever stroke. For tilt angle control of the hydraulic pump 10, the tilt angle control of the hydraulic pump 10 is performed such that the first and second hydraulic actuators 5 and 6 are activated in accordance with the operation of the operating levers 1a and 2a. At this time, feedback loop control is performed using the tilt angle signal of the hydraulic pump 10 detected by the tilt angle sensor 16 and the output pressure signal of the hydraulic pump 10 detected by the pressure sensor 18.

By integrating the activation control of the first and second control valves 7 and 8 to the tilt angle control of the hydraulic pump 10, improved fine control is possible. However, in most of steady control state, it is possible to control the first and second control valves 7 and 8 in accordance with the operation of the operating levers 1a and 2a and under this premise, independently perform the tilt angle control of the hydraulic pump 10. Thus, in this embodiment, the tilt angle control of the hydraulic pump 10 by the controller 20 is mainly described. Description on the activation control of the first and second control valves 7 and 8 integrated therewith is confined to portions in which coordination with the hydraulic pump 10 contributes to the improvement of a simultaneous operation to carry out this proposal in a more sophisticated manner. Note that, since the response characteristic of the pump tilt angle with respect to the operation of the operating levers 1a and 2a is lower than the response characteristic of the first and second control valves 7 and 8, control of delaying the activation of the first and second control valves 7 and 8 so that the pump tilt angle control catches up is performed within the controller 20 with respect to the first and second control valves 7 and 8, when transient control is necessary because of sudden operation of operating lever 1a or 2a.

The basic concept of hydraulic control by the controller 20 will be first described. The hydraulic control system shown herein uses a closed center directional control valve for the first and second control valves 7 and 8, is not provided with a center bypass circuit, and controls tilt control of the hydraulic pump 10 with the controller 20 through electricity. Accordingly, an improvement is made in energy loss due to center bypass notch and deterioration in controllability in the case of using an open center directional control valve, while ensuring the control characteristic achieved with a center bypass circuit in the case of using the open center directional control valve in a conventional manner.

In the hydraulic control system, a plurality of closed loop controls are used. Generally, a closed loop control refers to outputting, to a control target, a command value in which deviation is multiplied by gain such that the following expression is established: target value−feedback value (current value)=the deviation=0. At this time, it is often the case that the gain is of type one including one integrator so that the deviation (steady-state deviation) in the case where the target value is constant can be made zero. For example, integral I action in PI control or PID control is typical. Therefore, in this hydraulic control system, control of type one is made possible by removing mechanical feedback of pressure, tilt angle, or the like and taking an integral element inherent in a conventional pump tilt driving mechanism into a plurality of electric control system loops of speed (flow rate), force (pressure), horsepower (flow rate×pressure), or the like.

As a conventional and general method of electrically controlling a variable pump within a hydraulic system, using a variable displacement pump capable of flow rate control or pressure control with an electrical command amount is known. In this case, the tilt angle or output pressure of the pump is generally fed back for a closed loop control. That is, the closed loop control of the tilt angle or output pressure is incorporated in advance as a miner loop inside an electric control loop, and a flow rate command or pressure command is output from an electric control system. As such, in an electrical system, horsepower is converted to flow rate or pressure as the command to a pump with an electrical calculation, in the case where the control target is horsepower. Therefore, division is necessary, but this is not something digital calculation is well suited for. In contrast, in this hydraulic control system, it is possible to replace division with multiplication of feedback inputs (flow rate×pressure) for horsepower calculation, since tilt driving is done directly by type one control in the horsepower control loop.

It is often the case that speed, force, and horsepower are controlled simultaneously. Thus, horsepower, force, and speed are calculated constantly within the system. ‘Simultaneously’ means, for example, that a control such as the speed control where speed, as a base, is tracing on a certain speed profile with pressure or hose power limit set within preset value can be switched to another control in real time depending on the condition. Therefore, if the state of the system during speed control is within the setting value, control of pressure or horsepower substantially does not function. However, if the horsepower of the system reaches to the setting value, there is an immediate shift from the current control (speed control) to horsepower control.

In this hydraulic control system, simultaneous control is made possible by causing the selector unit 70 using sophisticated logical operations to select a control system to be established as a control loop out of control loops for control, and by switching them in real time depending on the state of the system.

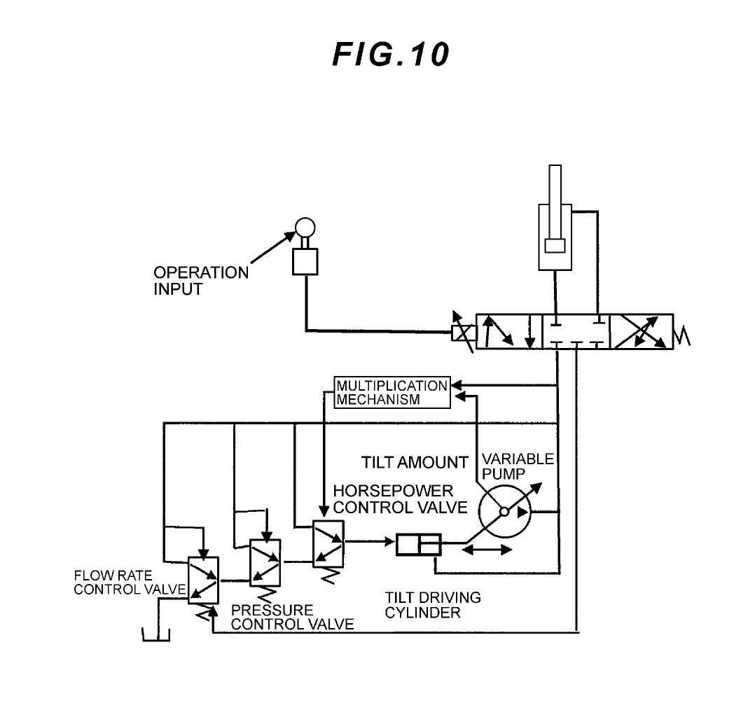

In a conventional system, there is an example of a load sensing system pump employing a form of cascade (chain) connection of a horsepower control loop, flow rate control loop, and pressure control loop in which a fixed setting value is directly assumed as a target value for an integral element inherent in a pump tilt driving mechanism. The configuration example is shown in FIG. 10.

In the example of FIG. 10, the target value of horsepower control or pressure control is a fixed target value instead of a variable target value based on operation input as in the system of this embodiment. In addition, a minimum value selection circuit is inherently incorporated for constantly selecting a control loop out of flow rate control, horsepower control, and pressure control to output a value always to reduce the tilt angle. This is inconvenient in a system that selectively uses flow rate, pressure, and horsepower control not only by minimum value selection but also by further sophisticated logical operations, depending on the operation input, feedback input, and combination thereof. For example, a minimum pressure holding loop takes action in the case where the load pressure has become less than or equal to the minimum value to behave in a tilt angle increasing direction, and thus is not a minimum value selection.

In the hydraulic control system of this embodiment, a sophisticated logical operation is performed by installing the selector unit 70 corresponding to operation input and feedback input within the controller, so that not only does each control loop take action with the variable target value based on operation input but also a function of more than mere minimum value selection is achieved.

In the hydraulic control system according to this embodiment, an operation input is taken into the controller, and controls a closed center directional control valve in correspondence with each actuator. Simultaneously, it is input to each control loop to determine the target value of pressure, the target value of flow rate, and the target value of horsepower. In a most general method, a two-dimensional pressure versus operation input table, flow rate versus operation input table, and horsepower versus operation input table are used. An example of the characteristic value tables is shown in FIG. 3. An operation input causes change in both plus and minus, but only the plus direction is shown in the example of FIG. 3. In FIG. 3, an example of the operation input versus pressure control characteristic is shown. The pressure control characteristic is defined for each actuator as a pressure increase characteristic with respect to operation input when the flow rate is zero. A plurality of designations is possible depending on the simultaneous action condition or the like.

In order to effectively use the operation input range and reduce needless strokes, the target value of the pressure control loop performed in the pressure control loop unit 40 jumps up near to a pressure necessary for no-load driving of the first and second actuators 5 and 6 when the operation input passes a neutral departing point, so that an action starting point is not too apart from the neutral departing point. Then, in accordance with the operation input versus pressure characteristic determined arbitrarily when the flow rate is zero, the pressure is increased. When the pressure increases to overcome the load, the actuators 5 and 6 start an action. In order to control startup smoothly without shock at this time, control of acceleration level is necessary. This is because a completely linear increasing maneuver in command value from zero is nearly impossible as far as with manual operation is concerned.

For example, when a command is given not linearly but in a step-like manner in the speed control (i.e., flow rate control) performed in the flow rate control loop unit 30, startup is attempted using the maximum acceleration performance given to the system in order to achieve the given target speed, causing a startup shock. This is similar for horsepower control performed in the horsepower control loop unit 50. Thus, in order to control the start of action smoothly, pressure control with which control of the acceleration level can be performed during this period is mandatory, and control by the pressure control loop unit 40 is selected by the selector unit 70. After the action starting point is passed, the actuators 5 and 6 gradually increase the speed according to operation input. In this case, if the load pressure is constant, control of the speed (i.e., control of the flow rate) can be defined as control along the horsepower control characteristic, since pressure times flow rate equals horsepower. An example of the control characteristic at the action starting point and thereafter is shown in the example of the operation input versus pressure control characteristic (FIG. 3) described above.

The horsepower control loop not only acts as a limiter for limiting the horsepower input to the variable pump from an engine to prevent an engine stall, but also acts for a driving horsepower control of the actuator corresponding to operation input. An appropriate characteristic value is determined continuously as the horsepower target value from zero up to the rated output of the engine. The horsepower target value is zero at the start of action, gradually increases along with a following increase in operation input, and is eventually defined on a curve that reaches the rated horsepower of the engine. Since the curve starts from the action starting point, the number of existence depends thereon. That is, since the action starting point is not in the neutral departing point (point S0-1) or less and not in a rated pressure reaching point (point S0-3) or greater, defining is possible in correspondence with the operation input therebetween. Further, since the required horsepower control characteristic varies for actuator by actuator depending on the simultaneous action condition or the like, defining is done for each actuator or simultaneous action condition according to necessity.

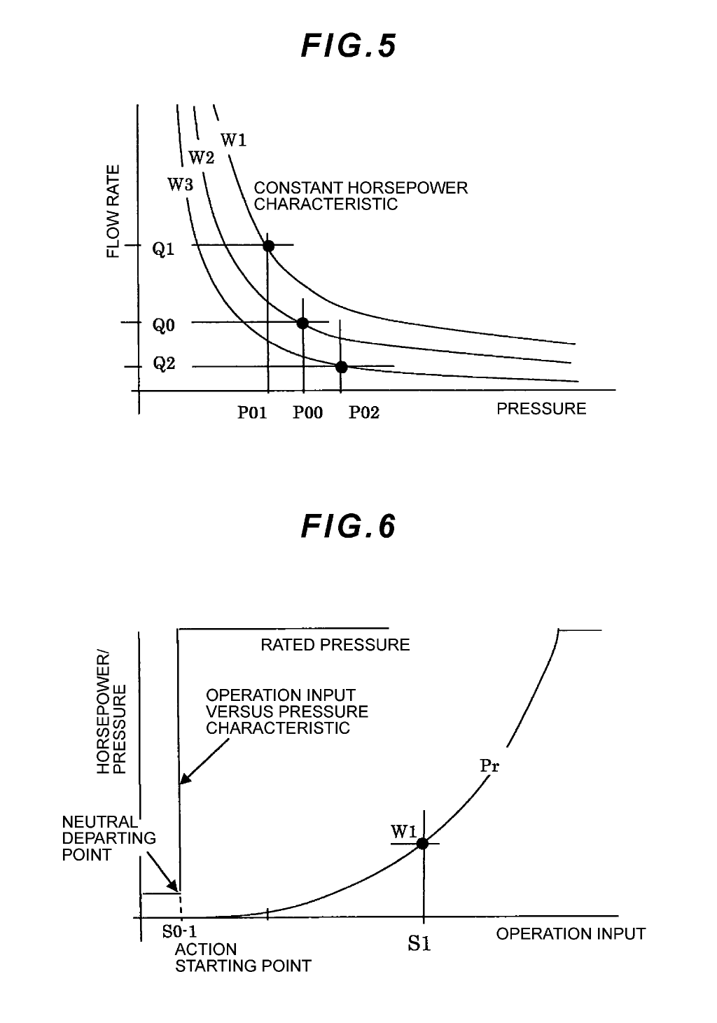

In this proposal, variable horsepower control corresponding to operation input is quite important and characteristic. The reason is not only that it becomes synonymous with the control of flow rate (i.e., speed control) under constant pressure. If the load (pressure) changes, the horsepower control loop changes the speed (flow rate) in order to ensure the target horsepower and it is possible for an operator to sense the change in load as a change in speed. That is, in an operation loop system including the operator, the speed change fulfills the role of feedback, and it thus becomes possible to form a reasonable operation system in terms of operating a machine. Description therefor is given with reference to FIG. 4 and FIG. 5.

The operation input versus pressure characteristic is the same as that shown in FIG. 3. The action starting point varies depending on the load pressure, and is between the neutral departing point (S0-1) and the rated pressure reaching point (S0-3). It is assumed that the pressure at point S0-1 on the operation input versus pressure characteristic is P01, the pressure at point S0-3 is P02, and the pressure at point S0-2 in the middle is P00. Then, the horsepower characteristic corresponding to the pressures P00, P01, and P02 can be defined. An operation input S1 results in W1, W2, or W3 corresponding to the load pressure (pressure feedback value), and the horsepower control loop takes action with this value as the horsepower target value.

A case where the load pressure has changed to P01 or P02 in a state where the system is causing the horsepower control loop to be in action with the operation input S1, the load pressure P00, and the horsepower target value W2 is shown in FIG. 5. In this figure, the pump discharge flow rate becomes Q1 or Q2 from Q0 due to pressure change, thus showing that the speed decreases as the pressure increases and increases as the pressure decreases.

As a special example, by making the operation input versus pressure characteristic increase from the minimum pressure to the rated pressure in a step-like manner near the neutral departing point, and then, by making the pressure control loop function as a rated pressure limiter (rated pressure control), it is possible to realize only one existing action starting point near the neutral departing point. Therefore, it is possible to reduce to only one horsepower characteristic. This example is shown in FIG. 6. If the load pressure is less than the rated pressure, the pressure control range=gets eliminated, so that the control can make an immediate shift from the neutral range to the horsepower control range. Note that, in this case, there is a risk that a shock exists at the time of startup.

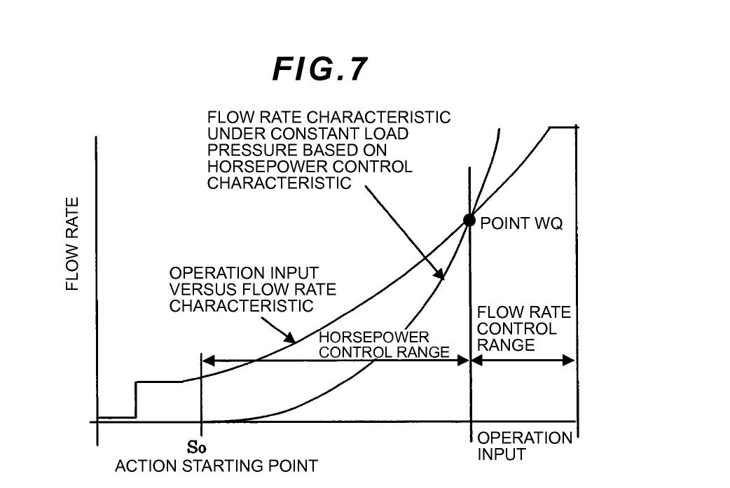

The flow rate control characteristic is defined as a curve that increases up to the maximum flow rate in accordance with the increase of operation input from a value determined by the minimum pressure holding flow rate plus some margin that compensates pressure for jumping up at the neutral departing point against leakage. In the case where the operation input is off the neutral position and the tilt angle feedback input is a flow rate (tilt angle) greater than or equal to the value determined by the operation input, the flow rate control loop is selected by the selector unit 70. In the case where it is less than that value, the horsepower control loop is selected by the selector unit 70. Thus, the relationship of the flow rate control characteristic and the horsepower control characteristic is important. An example of the relationship of the flow rate control characteristic and the horsepower control characteristic is shown in FIG. 7.

The horsepower control characteristic with respect to operation input under the condition assuming that the external load pressure on the actuator is constant can be represented same as the flow rate characteristic, as described above. In the example of FIG. 7, there is a point where the operation input and the flow rate are determined at an intersection point WQ of the flow rate characteristic curve based on the horsepower control characteristic and the flow rate control characteristic curve. The horsepower control characteristic with respect to operation input changes depending on the load pressure. Thus, point WQ also changes in accordance with the load pressure.

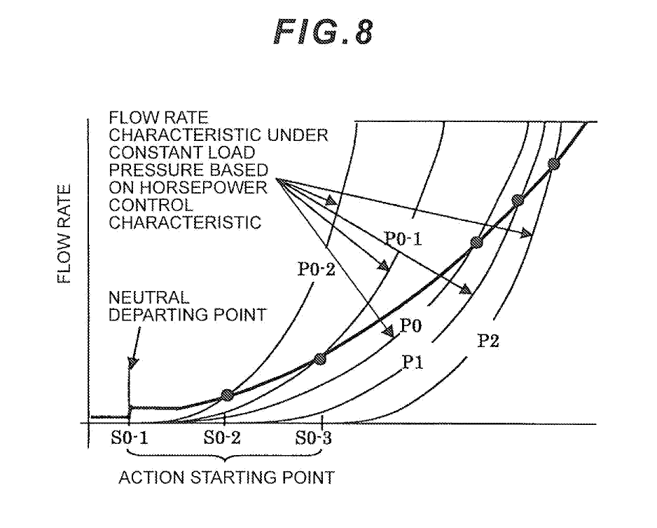

The locus of the intersection WQ is shown in FIG. 8. FIG. 8 shows the flow rate characteristic based on the horsepower control characteristic corresponding to pressures P0, P1, P2, P0-1, and P0-2, the operation input versus flow rate control characteristic curve, and intersections thereof. At P0-1 and P0-2, the load pressure is lower than the pressure P0 for which the action starting point is the neutral departing point. The same action starting point and the same horsepower control characteristic are applied to all conditions under the pressure P0, P0-1, and P0-2. In this manner, the flow rate control loop is selected by the selector unit 70 when the speed of the actuators 5 and 6 get bigger enough as described above, so that control turns to speed control executable without the influence from load pressure to give the operator a firm and forceful feeling.

The target value of the minimum pressure holding loop is generally a fixed value. It is determined in consideration of the minimum acceptable value for the pump tilt driving unit, necessary standby pressure for ensuring the startup response, requirement for energy saving in neutral, and the like. In the case where the actuator load is negative (meter-out side load), it is necessary to actively make up against insufficient flow rate from the pump side to balance the flow rate required from the load side and the flow rate supplied from the pump side. In an existing load sensing system or positive control system, the supply flow rate from a pump depends on the operation input. Therefore, balancing through an increase in pump supply flow rate is difficult. In a conventional and general measure, the insufficient supply from the pump is compensated for through sucking from a tank line via a check valve called a makeup valve or anti-void valve. However, since the tank line pressure is extremely low, the supply performance is limited. Therefore, for the insufficiency in supply performance, an approach of flow restriction in the meter-out circuit is mainly used to apply as a limit to the required flow rate from load side. In the case where the rotation of an engine is low, the more the tank line pressure decreases, and the worse the condition becomes. Since the minimum holding pressure is set higher than the tank pressure in this embodiment, it is possible to make the meter-out flow restrictor with bigger opening so that the energy saving properties can be increased.

When the system selects the pressure control loop or horsepower control loop, the flow rate increase characteristic of the variable pump is influenced and changed by the load pressure. In a conventional system, the spool stroke of a directional control valve is controlled only by operation input. Therefore, as a spool of the directional control valve moves greatly in accordance with the operation input regardless of the supply flow rate to an actuator being small or big, if the load pressure is high, the opening area becomes greater than necessary. However, according to this embodiment, since the pump discharge flow rate starts to increase at the action starting point determined by the load pressure of the actuator or thereafter, it is possible to prevent the opening area from becoming greater than necessary by determining the stroke of each spool of a closed center directional control valve in accordance with the pump flow rate increase characteristic.

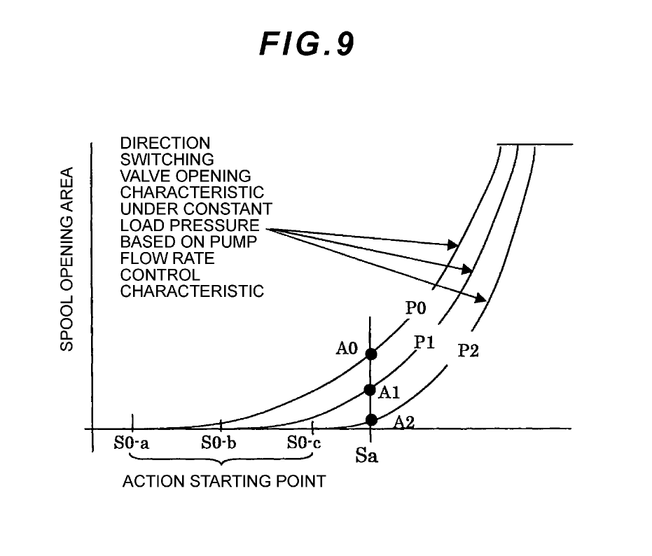

One example of spool stroke control is shown in FIG. 9. The actual opening characteristic is determined by a notch carved in the spool. That is, the opening characteristic is a characteristic unique with respect to a stroke, and therefore is stored in a controller in advance. Conventionally, the stroke of a spool of the first and second control valves 7 and 8 is generally controlled only by operation input. Thus, a spool opening starting point and the action starting point match only under certain load pressure. In this proposal, the action starting point with respect to operation input is obtainable from load pressure. Therefore, in accordance therewith, appropriately displacing the spool opening starting point and the opening characteristic enables the opening area of the directional control valve with respect to an operation input Sa to be A0 at the time of P0, A1 at the time of P1, and A2 at the time of P2. In order to cause a change among A0, A1, and A2 in correspondence with the operation input Sa, it suffices to obtain the stroke with respect to A0, A1, and A2 through backward reading of the opening characteristic corresponding to the stroke stored in the controller. Accordingly, changing the stroke of the spool in accordance with the pressure is achieved with the operation input as a basis.

For example, as a result of an operation to start the second actuator 6 with relatively high load pressure in a situation where the first actuator 5 is in action with an intermediate value of operation input, a command amount (command amount of pressure, horsepower, or flow rate loop) to a pump is added, and then, control tends to fall into a case in which the second actuator 6 with high load pressure does not start action and only the speed of the first actuator 5 is increased. Therefore, when the second actuator 6 is operated additionally while only the first actuator 5 has been operated with the load pressure P1, for example, the pump output pressure changes in the P0 direction if the load pressure of the second actuator 6 is lower with respect to P1, and in the P2 direction if higher. If the change is in the P0 direction, the flow rate of the first actuator 5 decreases. If the change is in the P2 direction, the flow rate is in an increasing direction. However, with this proposal, there is characteristic change in the opening area of the first control valve 7 simultaneously in the A0 direction or A2 direction. Therefore, a behavior can be caused in a direction to prevent from a shift in flow rate to the first actuator 5 generated due to the operation to the second actuator 6. On the second actuator 6 side, the characteristic is caused to be such that the pump output pressure is guided to be high if the load pressure on the first actuator 5 side is relatively high, so that the start of opening of the second control valve 8 is delayed, and the opening area is reduced with respect to operation input. Conversely, if the load pressure on the first actuator 5 side is relatively low, the pump output pressure is guided to be low. Therefore, the characteristic is caused to be such that the start of opening of the second control valve 8 is made earlier, and the opening area is increased with respect to operation input. As a result, a behavior can be caused in a direction to prevent from a shift in flow rate to the first actuator 5 generated due to the operation to the second actuator 6.

Thus, in this embodiment, the stroke of each spool of the first and second closed center control valves 7 and 8 is controlled by the operation input and load pressure, in consideration of the flow rate increase characteristic of the variable pump being influenced and changed by the load pressure. Accordingly, the opening characteristic of the notch of the valves 7 and 8 is coordinated with the pump discharge flow rate characteristic, and thus the simultaneous operation can be improved.

Next, how a pump drive system acts upon an increase in operation input will be described.

When Operation Input is in Neutral Position:

Control by the minimum pressure holding loop unit 60 is selected, and, the first and second closed center control valves 7 and 8 are held in the neutral position to make all ports blocked. Therefore, the pump is controlled in a minimum pressure state with approximately zero tilt angle. The necessary horsepower is approximately zero, and the loss in neutral is extremely small.

When Pump Output Pressure is Less than or Equal to Load Pressure:

When the input operation is started to get off the neutral position, control by the pressure control loop unit 40 is selected. The target value of the pressure control loop jumps up to an appropriate pressure so that the action starting point is not too apart from the neutral departing point, and then gradually increases in accordance with the increase in operation input up to an action starting pressure. The starting of action of the actuator is performed by pressure control. The first and second closed center control valves 7 and 8 are controlled such that the control refers to the characteristic based on the pressure when the start of opening overcomes the load pressure to start the action. A stroke keeps a degree of slight opening to wait for the pump output pressure to reach to the load pressure.

When Pump Output Pressure Reaches to Load Pressure and Actuator has Begun to Take Action:

When the hydraulic actuators 5 and 6 start action, control by the horsepower control loop unit 50 is selected. The target horsepower is increased by operation input to increase the pressure, flow rate, or both. That is, since the increase in speed varies depending on the load pressure, a change in load pressure can be fed back as a change in speed to the operator. With this feedback, the operator comes to know of the load state of each actuator, and an appropriate simultaneous operation becomes possible. The first and second closed center control valves 7 and 8 are controlled with the spool stroke determined by the operation input and the load pressure.

When Actuator Speed Increases Considerably and Operation Input has Increased Greater Enough for Flow Rate Control to Start:

Control by the flow rate control loop unit 30 is selected. Since a subtle operation is difficult and not necessary in this case, feedback of the load state is unnecessary. Therefore, a simple speed control by the flow rate control loop is sufficient. At this time, the speed is controlled without being influenced by a change in load pressure.

When Operation Input has Suddenly been Reduced:

Since the load speed tends to be ahead of the supply flow rate due to inertia on the actuator side, the load pressure decreases at first. Therefore, in the pressure control or horsepower control, the decrease in pump tilt angle tends to be slower than the closing speed of the first and second closed center control valves 7 and 8, and there is a risk that a high surge pressure occurs when valve spool reaches near to the closing stroke. In order to prevent the control from this, the flow rate control loop is selected in synchronization with the action of the closing first and second closed center control valves 7 and 8 in correspondence with the decrease in operation input, and the pump tilt angle is directly brought back in a direction toward zero.

When Actuator Load Pressure has Decreased to Minimum Pressure or Less:

Control by the minimum pressure holding loop unit 60 is selected. In the case where the actuator load is negative (meter-out side load), the actuator speed is ahead of the pump flow rate. Therefore, the pump output pressure decreases and becomes the minimum pressure or less, causing cavitation in the worst cases. In order to prevent this, it is necessary to actively compensate for the insufficient flow rate from the pump side to balance the flow rate required on the load side and the flow rate supplied from the pump side, and the minimum pressure holding loop takes action. With this function, it is possible to set the meter-out notch greater, and the energy saving properties can be increased.

The present invention includes a control method in which a condition for minimum pressure holding control is checked in real time to substitute the minimum pressure value forcefully for the command value of the pressure control loop at the point when the condition is met, and the pressure control loop is replaced with the minimum pressure holding loop.

With the control of the present invention, the following can be achieved.

I. By using the closed center directional control valve for the first and second control valves 7 and 8, eliminating a center bypass circuit, and controlling the tilt control of the hydraulic pump 10 with the controller 20 through electricity, energy loss in center bypass notch and deterioration in controllability due to hydro flow force can be improved while ensuring the control characteristic achieved with a center bypass circuit.

II. By removing mechanical feedback of pressure, tilt angle, or the like and taking an integral element inherent in a conventional pump tilt driving mechanism into a plurality of electric control system loops of speed (flow rate), force (pressure), horsepower (flow rate×pressure), or the like, control of type one with one built in integrator is made possible.

III. With separately variable target values for the horsepower control loop, pressure control loop, and flow rate control loop that are based on operation input and feedback input, it is possible to cause each loop to take action to smoothly activate the actuator.

III-1. By causing the selector unit 70 to select control by the pressure control loop unit 40 when the operation input passes the neutral departing point and increasing the pressure in accordance with the arbitrarily-determined operation input versus pressure characteristic when the flow rate is zero, it is possible to start the action smoothly through control of the acceleration level. Upon startup with manual operation, raising the speed linearly from zero becomes easier.

III-2. With the control by the horsepower control loop unit 50, not only is action caused as a limiter for limiting the horsepower input to the variable pump from the engine, but also a driving horsepower control of the actuator corresponding to the operation input is performed. Therefore, an appropriate characteristic value is determined continuously as the horsepower target value from zero up to the rated output of the engine. When the load (pressure) changes, the horsepower control loop changes the speed (flow rate) in order to ensure the target horsepower, and it is possible for the operator to sense the change in load as a change in speed. Accordingly, in the operation loop system including the operation by the operator, the speed change fulfills the role of feedback, and it is possible to form a reasonable operation system in terms of operating the machine.

III-3. When the speed of the hydraulic actuator increases, control by the flow rate control loop unit 30 is selected to enable speed control without the influence of load pressure, and it is possible to give the operator a firm and forceful feeling.

III-4. In the case where the actuator load is negative (meter-out side load), the actuator speed is ahead of the pump discharge flow rate. Therefore, the pump output pressure decreases and becomes the minimum pressure or less, causing cavitation in the worst cases. In order to prevent the control from this, control by the minimum pressure holding loop unit 60 takes action to actively compensate for the insufficient flow rate from the pump side and balance the flow rate required on the load side and the flow rate supplied from the pump side. With this function, it is possible to set the meter-out notch greater, and the energy saving properties can be improved.

IV. In order to achieve a function that is more than mere minimum value selection, a logical operation corresponding to the operation input and feedback input is applied within the controller 20, such that the selector unit 70 takes action to select a control system to be established as a loop out of the horsepower control loop, pressure control loop, flow rate control loop, and minimum pressure holding loop. Depending on the state of the system at this time, the control loops can be switched in real time to perform simultaneous control.

V. The stroke of each spool of the first and second closed center control valves 7 and 8 is controlled by the operation input and load pressure, in consideration of the flow rate increase characteristic of the variable pump being influenced and changed by the load pressure. Accordingly, it is possible to improve the simultaneous operation through coordination of the opening characteristic of the notch of the first and second control valves 7 and 8 with the pump output flow rate characteristic.

### EXPLANATION OF NUMERALS AND CHARACTERS

1, 2 First and second operation devices
5, 6 First and second hydraulic actuators
7, 8 First and second control valves
10 Hydraulic pump
12 Tilt driving cylinder
14 Tilt control valve
20 Controller
30 Flow rate control loop unit
40 Pressure control loop unit
50 Horsepower control loop unit
60 Minimum pressure holding loop unit
70 Selector

1-7. (canceled)

8. A hydraulic control system in which hydraulic oil discharged from a variable displacement hydraulic pump is controlled and supplied to a hydraulic actuator by a closed center control valve activated based on operation input from an operation device thereby controlling activation of the hydraulic actuator,
the hydraulic control system comprising:
pump displacement detecting means for detecting a displacement of the hydraulic pump; and
pump output pressure detecting means for detecting an output pressure of the hydraulic pump,
the hydraulic pump being configured such that, with a pump displacement detected by the pump displacement detecting means and a pump output pressure detected by the pump output pressure detecting means being used as feedback input and a characteristic value determined by the operation input and the feedback input being used as a target value of a control loop, variable displacement control is performed by a controller provided with a horsepower control loop, a pressure control loop, a flow rate control loop, and a minimum pressure holding loop that feed back a calculated value based on the feedback input or the feedback input itself, and
the controller being provided with a selector unit that selects any of the plurality of loops in correspondence with the operation input and the feedback input so that any loop out of a plurality of the loops is selected by the selector unit and variable displacement control of the hydraulic pump is performed based on a control value from the selected loop.

9. The hydraulic control system according to claim 8, comprising a plurality of hydraulic actuator, wherein
a characteristic value table of flow rate, pressure, and horsepower corresponding to the operation input and the feedback input is set for each of the plurality of the hydraulic actuators, and target values of flow rate, pressure, and horsepower in the plurality of loops are determined with reference to the characteristic value tables.

10. The hydraulic control system according to claim 8, wherein the selector unit
(1) selects a minimum pressure holding loop when the operation input indicates that the operation device is in a neutral position,
(2) selects the pressure control loop when the operation input indicates that the operation device is off the neutral position and the pump displacement is less than or equal to a leakage flow of a hydraulic oil supply circuit for the hydraulic actuator and that the hydraulic actuator is in a state before activation,
(3) selects the horsepower control loop when the operation input indicates that the operation device is off the neutral position and the pump displacement becomes greater than or equal to the leakage flow of the hydraulic oil supply circuit for the hydraulic actuator and is less than or equal to a displacement determined by the operation input signal, and
(4) selects the flow rate control loop when the operation input indicates that the operation device is off the neutral position and the pump displacement is a displacement exceeding the displacement determined by the operation input signal.

11. The hydraulic control system according to claim 10, wherein, the selector unit
(5) selects the minimum pressure holding loop when the pump output pressure detected by the pump output pressure detecting means has become smaller than a minimum allowable pressure, regardless of the operation input.

12. The hydraulic control system according to claim 11, wherein, the selector unit
(6) selects the flow rate control loop in a case where the operation input has suddenly decreased due to a sudden operation to neutral, and control of forcefully reducing the displacement of the hydraulic pump is performed by the flow rate control loop.

13. The hydraulic control system according to claim 10, wherein, when a selection of shifting from the pressure control loop to the horsepower control loop has been performed, the characteristic value of the horsepower control table is caused to vary by referring to a pressure exhibited when the actuator overcomes a load pressure and starts activation.

14. The hydraulic control system according to claim 8, wherein
the controller is configured to control activation of the closed center control valve based on the operation input and the pump output pressure, and
opening control in the closed center control valve is to be caused to coordinate with displacement control of the hydraulic pump so as to make a start of opening have a characteristic, in which a pressure exhibited when overcoming a load pressure to start activation is used as a reference, such that valve opening is greater when the load pressure is low and valve opening is smaller when the load pressure is high.
